(19) United States
(12) Patent Application Publication
(10) Pub. No.: US 2025/0026295 A1
(43) Pub. Date: Jan. 23, 2025

(54) VEHICLE REINFORCING MEMBER

(71) Applicants: Hyundal Motor company, Seoul (KR); Kia Corporation, Seoul (KR)

(72) Inventor: Seong Wook Seo, Hwaseong-si (KR)

(21) Appl. No.: 18/496,118

(22) Filed: Oct. 27, 2023

(30) Foreign Application Priority Data
Jul. 17, 2023 (KR) 10-2023-0092614

(51) Int. Cl. B60R 21/02; B60R 5/04; B62D 25/08

(52) U.S. Cl. CPC B60R 21/026; B60R 5/04; B62D 25/087

(57) ABSTRACT

An embodiment vehicle reinforcing member includes a first extension portion extending to a predetermined length, a second extension portion spaced apart from the first extension portion, a first upper mounting portion disposed at a top end of the first extension portion and a second upper mounting portion disposed at a top end of the second extension portion, and a first lower mounting portion disposed at a bottom end of the first extension portion and a second lower mounting portion disposed at a bottom end of the second extension portion.

### CROSS-REFERENCE TO RELATED APPLICATIONS

This application claims the benefit of Korean Patent Application No. 10-2023-0092614, filed on Jul. 17, 2023, which application is hereby incorporated herein by reference.

### TECHNICAL FIELD

The present disclosure relates to a vehicle reinforcing member.

### BACKGROUND

A vehicle includes various reinforcing members for suppressing deformation of a vehicle body and improving stiffness of the vehicle body. The reinforcing members may have various structures considering their mounting positions, connections to peripheral components/parts, and the like.

The vehicle may include a partition by which a passenger compartment and a rear compartment (luggage space, trunk room, and the like) are divided. According to the related art, stiffness of the partition may be increased by a reinforcing member having a single cross section.

However, since the related art reinforcing member has a single cross section, it may be difficult to suppress deformation of the partition and the vehicle body. In particular, there is a limit to increasing stiffness of the partition and the vehicle body.

The above information described in this background section is provided to assist in understanding the background of the inventive concept and may include any technical concept which is not considered as the prior art that is already known to those skilled in the art.

### SUMMARY

The present disclosure relates to a vehicle reinforcing member. Particular embodiments relate to a vehicle reinforcing member designed to improve torsional stiffness of a vehicle body by suppressing deformation of the vehicle body.

Embodiments of the present disclosure can solve problems occurring in the prior art while advantages achieved by the prior art are maintained intact.

An embodiment of the present disclosure provides a vehicle reinforcing member designed to improve torsional stiffness of a partition and a vehicle body by suppressing deformation of the partition and the vehicle body.

According to an embodiment of the present disclosure, a vehicle reinforcing member may include a first extension portion extending to a predetermined length, a second extension portion spaced apart from the first extension portion, an upper mounting portion provided at a top end of the first extension portion and a top end of the second extension portion, and a lower mounting portion provided at a bottom end of the first extension portion and a bottom end of the second extension portion.

The first extension portion may be spaced apart from the second extension portion along a longitudinal axis of a vehicle body.

The first extension portion may be spaced apart from the second extension portion along a width axis of a vehicle body.

The first extension portion may be spaced apart from the second extension portion along a height axis of a vehicle body.

The vehicle reinforcing member may further include a middle connection portion connecting the first extension portion and the second extension portion.

The upper mounting portion may be offset with respect to the top end of the first extension portion and the top end of the second extension portion.

The vehicle reinforcing member may further include an upper connection portion connecting the top end of the first extension portion and the top end of the second extension portion to the upper mounting portion.

A cross section of the upper connection portion may gradually change from the top end of the first extension portion and the top end of the second extension portion toward the upper mounting portion.

The lower mounting portion may be offset with respect to the bottom end of the first extension portion and the bottom end of the second extension portion.

The vehicle reinforcing member may further include a lower connection portion connecting the bottom end of the first extension portion and the bottom end of the second extension portion to the lower mounting portion.

A cross section of the lower connection portion may gradually change from the bottom end of the first extension portion and the bottom end of the second extension portion toward the lower mounting portion.

The upper mounting portion may be mounted on an upper portion of a partition of a vehicle body, and the lower mounting portion may be mounted on a side portion of the partition of the vehicle body.

The upper mounting portion may include cylindrical hardware through which a fastener extends, and the lower mounting portion may include cylindrical hardware through which a fastener extends.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 illustrates a perspective view of a state in which a vehicle reinforcing member according to an exemplary embodiment of the present disclosure is mounted on a partition;

FIG. 2 illustrates an enlarged view of portion A of FIG. 1;

FIG. 3 illustrates an enlarged view of portion B of FIG. 1;

FIG. 4 illustrates a front view of a state in which a vehicle reinforcing member according to an exemplary embodiment of the present disclosure is mounted on a partition;

FIG. 5 illustrates a cross-sectional view, taken along line C-C of FIG. 4;

FIG. 6 illustrates an enlarged view of portion D of FIG. 5;

FIG. 7 illustrates a vehicle reinforcing member according to an exemplary embodiment of the present disclosure;

FIG. 8 illustrates an enlarged view of portion E of FIG. 7;

FIG. 9 illustrates a cross-sectional view, taken along line F-F of FIG. 8;

FIG. 10 illustrates a perspective view of an upper connection portion, a lower connection portion, an upper mounting portion, and a lower mounting portion in a vehicle reinforcing member according to an exemplary embodiment of the present disclosure;

FIG. 11 illustrates a cross-sectional view, taken along line G-G of FIG. 10;

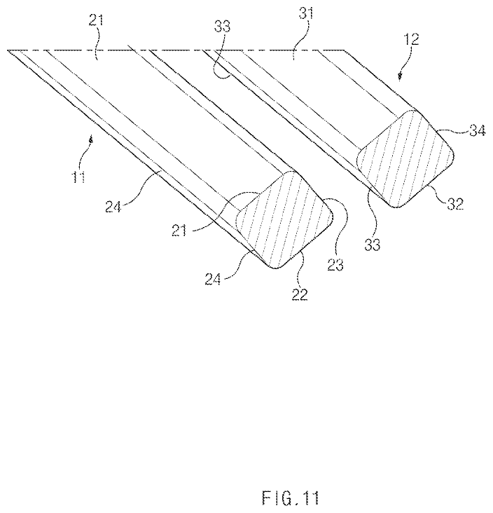

FIG. 12 illustrates a cross-sectional view, taken along line H-H of FIG. 10;

FIG. 13 illustrates a cross-sectional view, taken along line I-I of FIG. 10;

FIG. 14 illustrates a cross-sectional view, taken along line J-J of FIG. 10; and

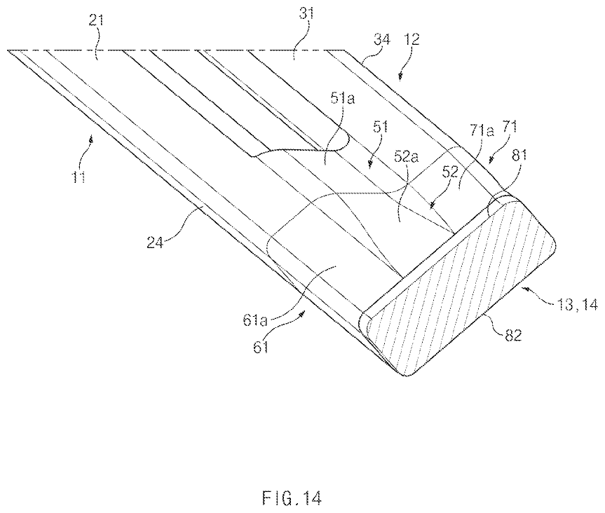

FIG. 15 illustrates a cross-sectional view, taken along line K-K of FIG. 10.

### DETAILED DESCRIPTION OF ILLUSTRATIVE EMBODIMENTS

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with embodiments of the present disclosure will be omitted in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art and are not to be interpreted as having ideal or excessively formal meanings unless clearly defined as having such in the present application.

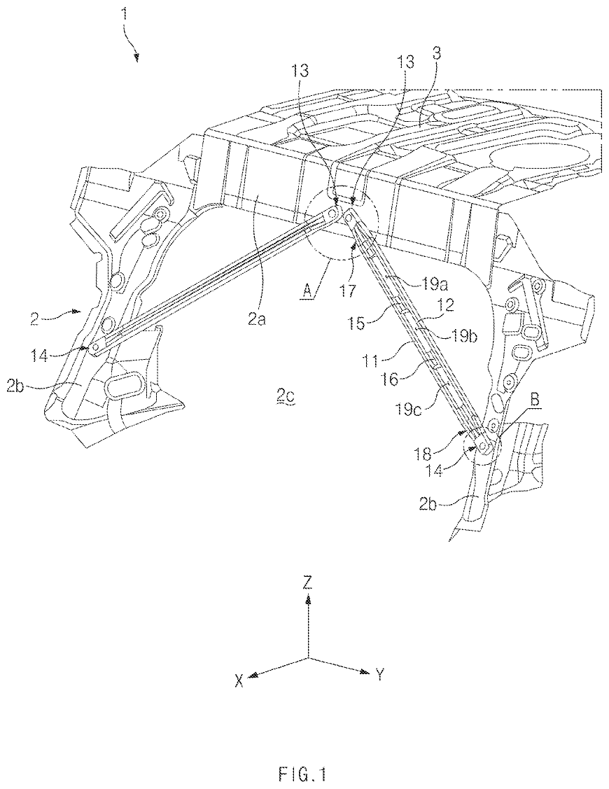

Referring to FIG. 1, a vehicle body may include a partition 1 located between a passenger compartment and a rear compartment (luggage space, trunk room, and the like). The partition 1 may have a front wall 2 and a top wall 3 extending horizontally from a top edge of the front wall 2 toward the rear of the vehicle body. The front wall 2 may include an upper portion 2a and a pair of side portions 2b. The front wall 2 may have an opening 2c defined by the upper portion 2a and the pair of side portions 2b.

The partition 1 may be configured to separate the passenger compartment from the rear compartment in the rear of the vehicle body. When strength and stiffness of the partition 1 are not obtained, deformation of the vehicle body may occur. Accordingly, at least one reinforcing member 10 may be mounted on the partition 1 so that stiffness and strength of the partition 1 may be increased.

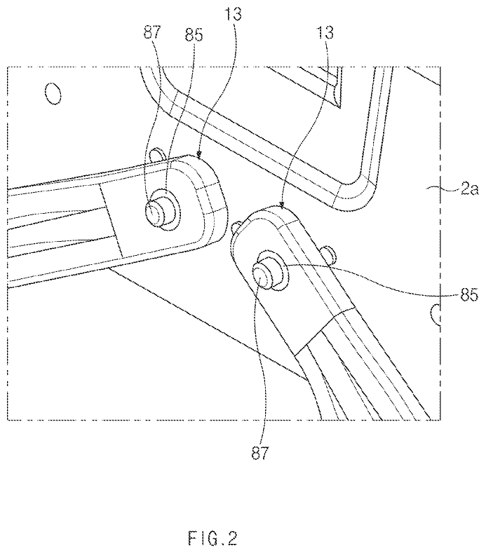

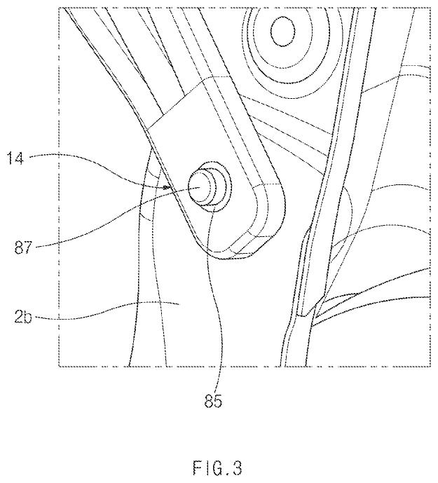

Referring to FIG. 1, two reinforcing members 10 may be disposed symmetrically and obliquely with respect to the partition 1. Each reinforcing member 10 may extend to a predetermined length, and a pair of mounting portions 13 and 14 may be provided at both ends of the reinforcing member 10. Referring to FIG. 2, an upper mounting portion 13 of each reinforcing member 10 may be mounted on the upper portion 2a of the front wall 2 of the partition 1 using a fastener such as a bolt 87. Referring to FIG. 3, a lower mounting portion 14 of each reinforcing member 10 may be mounted on the side portion 2b of the front wall 2 of the partition 1 using a fastener such as a bolt 87. The upper mounting portion 13 and the lower mounting portion 14 may have a single cross section.

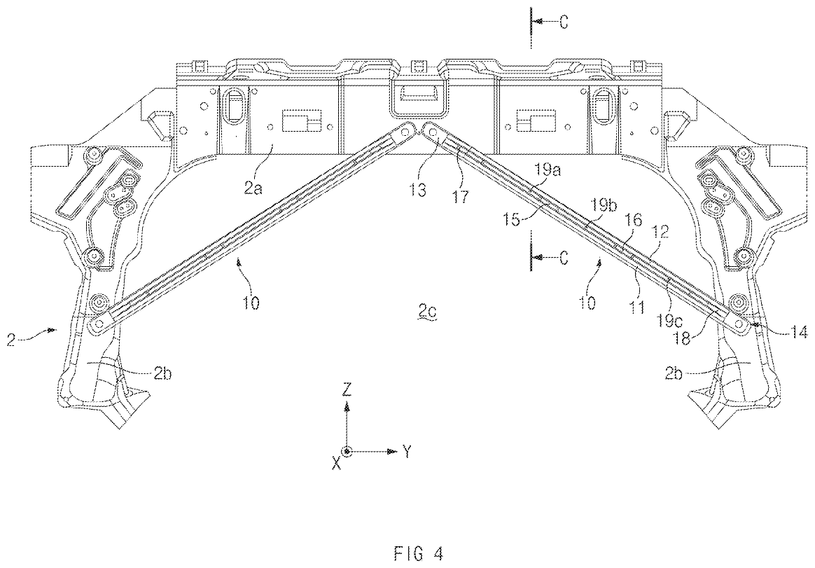

Referring to FIGS. 1 and 4, the reinforcing member 10 may include a first extension portion 11 extending along a longitudinal direction thereof and a second extension portion 12 spaced apart from the first extension portion 11. The second extension portion 12 may be parallel to the first extension portion 11, and a length of the second extension portion 12 may be equal to or similar to that of the first extension portion 11. Accordingly, the reinforcing member 10 may have a double cross section by the cross section of the first extension portion 11 and the cross section of the second extension portion 12. The cross section of the first extension portion 11 and the cross section of the second extension portion 12 may have various shapes such as a circular shape, a triangular shape, and a rectangular shape. A top end of the first extension portion 11 and a top end of the second extension portion 12 may be integrally connected to the upper mounting portion 13, and a bottom end of the first extension portion 11 and a bottom end of the second extension portion 12 may be integrally connected to the lower mounting portion 14.

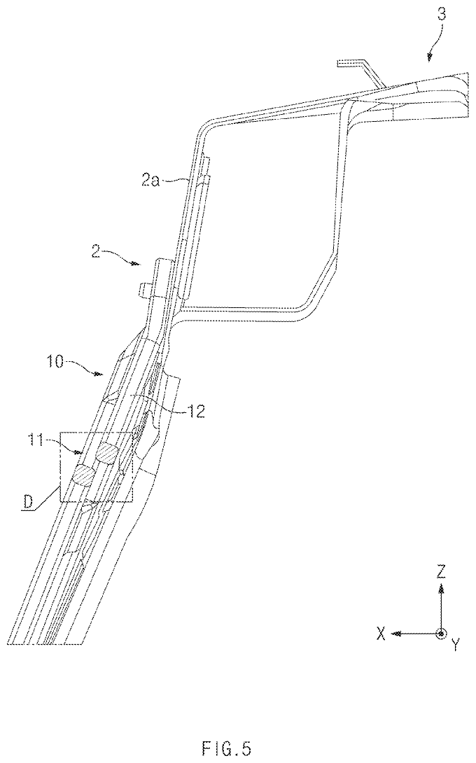

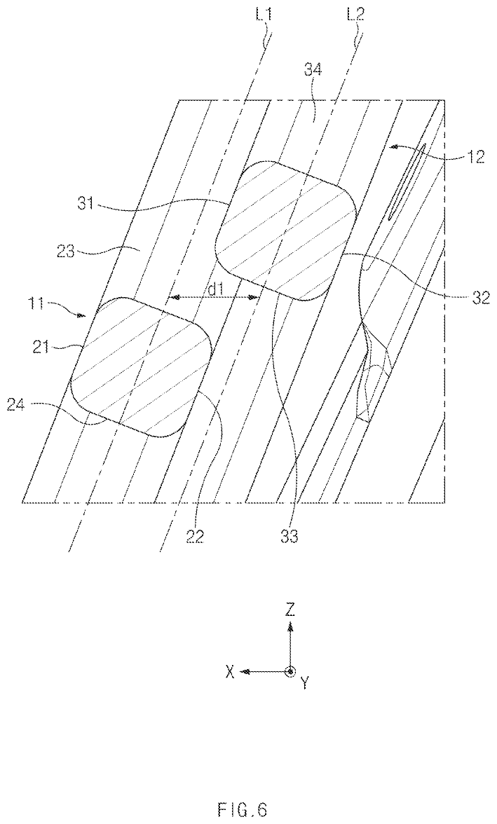

Referring to FIG. 5, the first extension portion 11 may be spaced apart from the second extension portion 12 along a longitudinal axis X of the vehicle body. Referring to FIG. 6, a longitudinal axis L1 of the first extension portion 11 may be spaced apart from a longitudinal axis L2 of the second extension portion 12 by a first distance d1 along the longitudinal axis X of the vehicle body. As the first extension portion 11 is spaced apart from the second extension portion 12, the second moment of area IYY of the reinforcing member 10 with respect to a width axis Y of the vehicle body may increase, and as the second moment of area IYY with respect to the width axis Y of the vehicle body increases, bending stiffness of the reinforcing member 10 with respect to the partition 1 and the longitudinal axis X of the vehicle body may be improved.

Referring to FIG. 6, the first extension portion 11 may be located in front of the second extension portion 12, and accordingly the first extension portion 11 may be closer to the front of the vehicle than the second extension portion 12. The first extension portion 11 may include a front surface 21 facing the front of the vehicle, a rear surface 22 facing the rear of the vehicle, and a pair of side surfaces 23 and 24 facing both sides of the vehicle, respectively. The second extension portion 12 may include a front surface 31 facing the front of the vehicle, a rear surface 32 facing the rear of the vehicle, and a pair of side surfaces 33 and 34 facing both sides of the vehicle, respectively. The front surface 21 of the first extension portion 11 may be offset from the front surface 31 of the second extension portion 12 toward the front of the vehicle, and the rear surface 22 of the first extension portion 11 may be offset from the rear surface 32 of the second extension portion 12 toward the front of the vehicle.

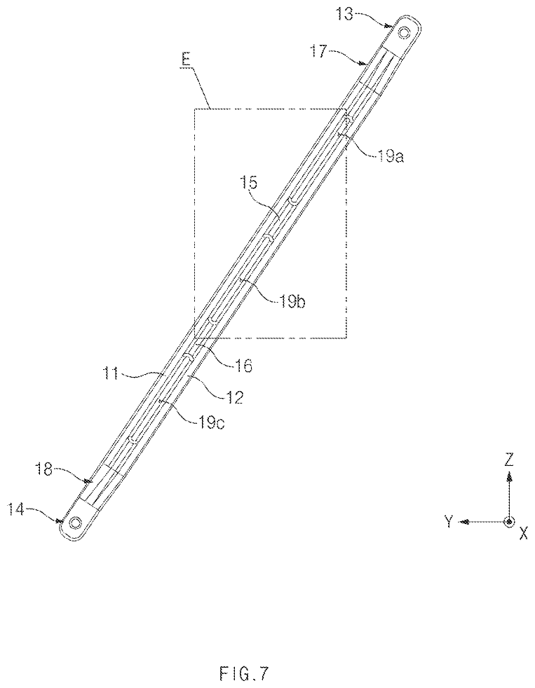

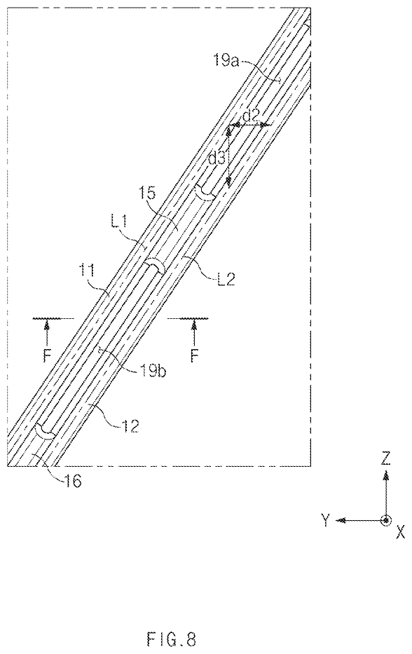

Referring to FIG. 7, the first extension portion 11 may be spaced apart from the second extension portion 12 along the width axis Y of the vehicle body. Referring to FIG. 8, the longitudinal axis L1 of the first extension portion 11 may be spaced apart from the longitudinal axis L2 of the second extension portion 12 by a second distance d2 along the width axis Y of the vehicle body. As the first extension portion 11 is spaced apart from the second extension portion 12, the second moment of area IXX of the reinforcing member 10 with respect to the longitudinal axis X of the vehicle body may increase, and as the second moment of area IXX with respect to the longitudinal axis X of the vehicle body increases, bending stiffness of the reinforcing member 10 with respect to the partition 1 and the width axis Y of the vehicle body may be improved.

Referring to FIG. 7, the first extension portion 11 may be spaced apart from the second extension portion 12 along a height axis Z of the vehicle body. Referring to FIG. 8, the longitudinal axis L1 of the first extension portion 11 may be spaced apart from the longitudinal axis L2 of the second extension portion 12 by a third distance d3 along the height axis Z of the vehicle body.

The reinforcing member 10 according to an exemplary embodiment of the present disclosure may include one or more middle connection portions 15 and 16 by which the first extension portion 11 and the second extension portion 12 are connected. As a force acts on the reinforcing member 10, and the reinforcing member 10 is deformed, the middle connection portions 15 and 16 may connect the first extension portion 11 and the second extension portion 12, thereby preventing deformation of the first extension portion 11 and deformation of the second extension portion 12.

Referring to FIG. 7, the plurality of middle connection portions 15 and 16 may be spaced apart from each other between the first extension portion 11 and the second extension portion 12 along the longitudinal direction of the reinforcing member 10. The reinforcing member 10 may have a plurality of slots 19a, 19b, and 19c defined by the first extension portion 11, the second extension portion 12, and the plurality of middle connection portions 15 and 16.

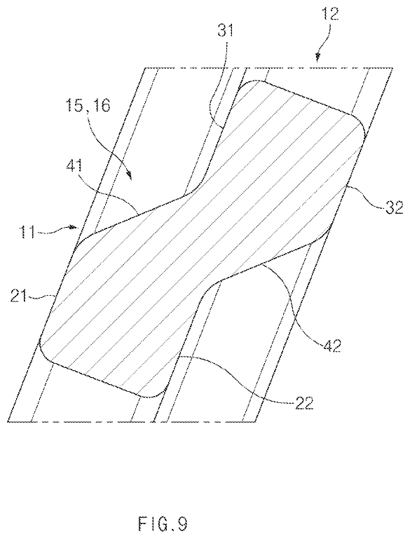

Referring to FIG. 9, each of the middle connection portions 15 and 16 may include a front surface 41 facing the front of the vehicle and a rear surface 42 facing the rear of the vehicle. The front surface 41 of each of the middle connection portions 15 and 16 may connect the front surface 21 of the first extension portion 11 and the front surface 31 of the second extension portion 12, and the rear surface 42 of each of the middle connection portions 15 and 16 may connect the rear surface 22 of the first extension portion 11 and the rear surface 32 of the second extension portion 12.

Referring to FIG. 9, the front surface 21 of the first extension portion 11 may be spaced apart from the front surface 31 of the second extension portion 12 toward the front of the vehicle body, and the rear surface 22 of the first extension portion 11 may be spaced apart from the rear surface 32 of the second extension portion 12 toward the front of the vehicle body. The front surface 41 of each of the middle connection portions 15 and 16 may be inclined with respect to the front surface 21 of the first extension portion 11 and the front surface 31 of the second extension portion 12 at a predetermined angle, and the rear surface 42 of each of the middle connection portions 15 and 16 may be inclined with respect to the rear surface 22 of the first extension portion 11 and the rear surface 32 of the second extension portion 12 at a predetermined angle.

The reinforcing member 10 according to an exemplary embodiment of the present disclosure may include an upper connection portion 17 connecting the top end of the first extension portion 11 and the top end of the second extension portion 12 to the upper mounting portion 13, and the reinforcing member 10 may include a lower connection portion 18 connecting the bottom end of the first extension portion 11 and the bottom end of the second extension portion 12 to the lower mounting portion 14.

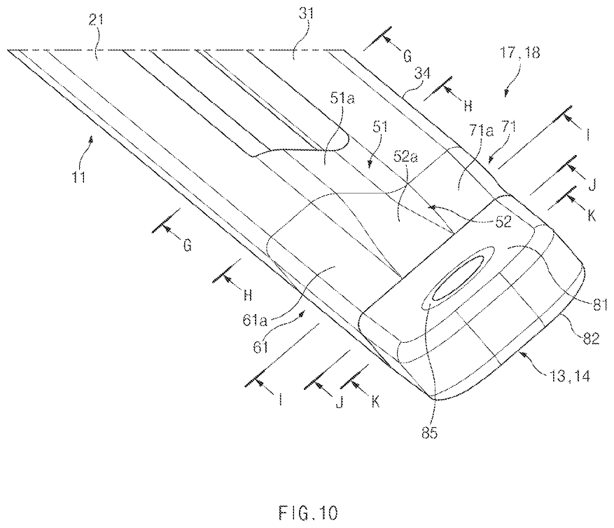

A cross section of the upper connection portion 17 may be designed to gradually change from the top end of the first extension portion 11 and the top end of the second extension portion 12 toward the upper mounting portion 13. Referring to FIG. 10, the upper connection portion 17 may include a first end extension portion 61 extending from the top end of the first extension portion 11 to the upper mounting portion 13 along the longitudinal direction of the reinforcing member 10, a second end extension portion 71 extending from the top end of the second extension portion 12 to the upper mounting portion 13 along the longitudinal direction of the reinforcing member 10, a first connection rib 51 connecting the top end of the first extension portion 11 and the top end of the second extension portion 12 along a width direction of the reinforcing member 10, and a second connection rib 52 connecting the first end extension portion 61 and the second end extension portion 71 along the width direction of the reinforcing member 10.

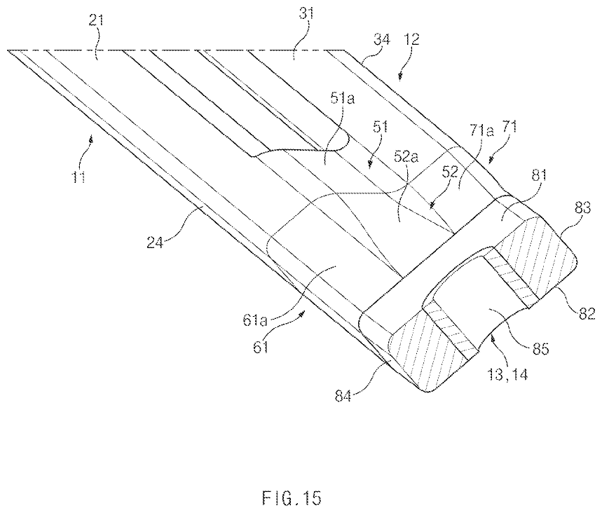

The upper mounting portion 13 may be offset with respect to the top end of the first extension portion 11 and the top end of the second extension portion 12. A front surface 81 of the upper mounting portion 13 may be offset with respect to the front surface 21 of the first extension portion 11 and the front surface 31 of the second extension portion 12, and a rear surface 82 of the upper mounting portion 13 may be offset with respect to the rear surface 22 of the first extension portion 11 and the rear surface 32 of the second extension portion 12. The upper mounting portion 13 may have a single flat cross section. Referring to FIG. 15, a first side surface 83 of the upper mounting portion 13 may be integrally connected to one side surface 24 of the first extension portion 11, and a second side surface 84 of the upper mounting portion 13 may be integrally connected to one side surface 34 of the second extension portion 12.

Referring to FIG. 10, the first end extension portion 61 may extend from the top end of the first extension portion 11 toward the upper mounting portion 13 along the longitudinal direction of the reinforcing member 10. To correspond to an offset distance between the first extension portion 11 and the upper mounting portion 13, the first end extension portion 61 may be inclined from the top end of the first extension portion 11 toward the upper mounting portion 13.

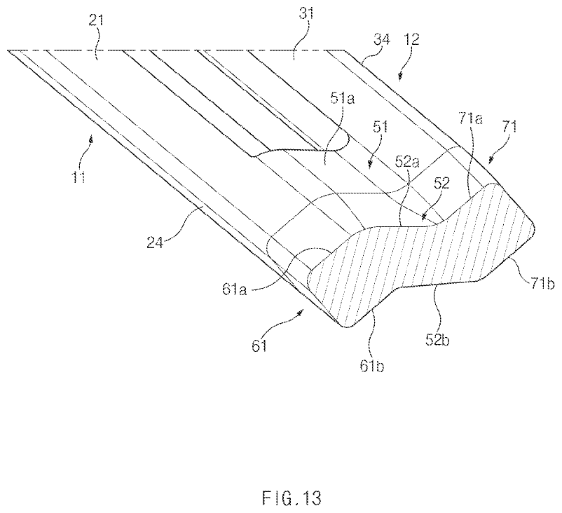

Referring to FIG. 13, the first end extension portion 61 may include a front surface 61a connecting the front surface 21 of the first extension portion 11 and the front surface 81 of the upper mounting portion 13, and the first end extension portion 61 may include a rear surface 61b connecting the rear surface 22 of the first extension portion 11 and the rear surface 82 of the upper mounting portion 13. The front surface 61a of the first end extension portion 61 may be inclined to correspond to an offset distance between the front surface 21 of the first extension portion 11 and the front surface 81 of the upper mounting portion 13. The rear surface 61b of the first end extension portion 61 may be inclined to correspond to an offset distance between the rear surface 22 of the first extension portion 11 and the rear surface 82 of the upper mounting portion 13.

Referring to FIG. 10, the second end extension portion 71 may extend from the top end of the second extension portion 12 toward the upper mounting portion 13 along the longitudinal direction of the reinforcing member 10. To correspond to an offset distance between the second extension portion 12 and the upper mounting portion 13, the second end extension portion 71 may be inclined from the top end of the second extension portion 12 toward the upper mounting portion 13.

Referring to FIG. 13, the second end extension portion 71 may include a front surface 71a connecting the front surface 31 of the second extension portion 12 and the front surface 81 of the upper mounting portion 13, and the second end extension portion 71 may include a rear surface 71b connecting the rear surface 32 of the second extension portion 12 and the rear surface 82 of the upper mounting portion 13. The front surface 71a of the second end extension portion 71 may be inclined to correspond to an offset distance between the front surface 31 of the second extension portion 12 and the front surface 81 of the upper mounting portion 13. The rear surface 71b of the second end extension portion 71 may be inclined to correspond to an offset distance between the rear surface 32 of the second extension portion 12 and the rear surface 82 of the upper mounting portion 13.

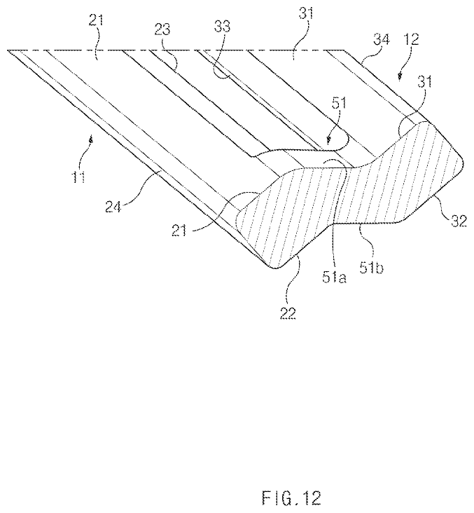

Referring to FIG. 12, the first connection rib 51 may connect the top end of the first extension portion 11 and the top end of the second extension portion 12 along the width direction of the reinforcing member 10. The first connection rib 51 may include a front surface 51a connecting the front surface 21 of the first extension portion 11 and the front surface 31 of the second extension portion 12, and the first connection rib 51 may include a rear surface 51b connecting the rear surface 22 of the first extension portion 11 and the rear surface 32 of the second extension portion 12. The front surface 51a of the first connection rib 51 may be inclined to correspond to an offset distance between the front surface 21 of the first extension portion 11 and the front surface 31 of the second extension portion 12. The rear surface 51b of the first connection rib 51 may be inclined to correspond to an offset distance between the rear surface 22 of the first extension portion 11 and the rear surface 32 of the second extension portion 12.

Referring to FIG. 13, the second connection rib 52 may connect the first end extension portion 61 and the second end extension portion 71 along the width direction of the reinforcing member 10. The second connection rib 52 may include a front surface 52a connecting the front surface 61a of the first end extension portion 61 and the front surface 71a of the second end extension portion 71, and the second connection rib 52 may include a rear surface 52b connecting the rear surface 61b of the first end extension portion 61 and the rear surface 71b of the second end extension portion 71. The front surface 52a of the second connection rib 52 may be inclined to correspond to an offset distance between the front surface 61a of the first end extension portion 61 and the front surface 71a of the second end extension portion 71. The rear surface 52b of the second connection rib 52 may be inclined to correspond to an offset distance between the rear surface 61b of the first end extension portion 61 and the rear surface 71b of the second end extension portion 71. An angle of inclination of the front surface 52a of the second connection rib 52 and an angle of inclination of the rear surface 52b of the second connection rib 52 may gradually decrease toward the upper mounting portion 13.

A cross section of the lower connection portion 18 may be designed to gradually change from the bottom end of the first extension portion 11 and the bottom end of the second extension portion 12 toward the lower mounting portion 14. Referring to FIG. 10, the lower connection portion 18 may include the first end extension portion 61 extending from the bottom end of the first extension portion 11 to the lower mounting portion 14 along the longitudinal direction of the reinforcing member 10, the second end extension portion 71 extending from the bottom end of the second extension portion 12 to the lower mounting portion 14 along the longitudinal direction of the reinforcing member 10, the first connection rib 51 connecting the bottom end of the first extension portion 11 and the bottom end of the second extension portion 12 along the width direction of the reinforcing member 10, and the second connection rib 52 connecting the first end extension portion 61 and the second end extension portion 71 along the width direction of the reinforcing member 10.

The lower mounting portion 14 may be offset with respect to the first extension portion 11 and the second extension portion 12. A front surface 81 of the lower mounting portion 14 may be offset with respect to the front surface 21 of the first extension portion 11 and the front surface 31 of the second extension portion 12, and a rear surface 82 of the lower mounting portion 14 may be offset with respect to the rear surface 22 of the first extension portion 11 and the rear surface 32 of the second extension portion 12. The lower mounting portion 14 may have a single flat cross section. Referring to FIG. 15, the first side surface 83 of the lower mounting portion 14 may be integrally connected to one side surface 24 of the first extension portion 11, and the second side surface 84 of the lower mounting portion 14 may be integrally connected to one side surface 34 of the second extension portion 12.

Referring to FIG. 10, the first end extension portion 61 may extend from the bottom end of the first extension portion 11 toward the lower mounting portion 14 along the longitudinal direction of the reinforcing member 10. To correspond to an offset distance between the first extension portion 11 and the lower mounting portion 14, the first end extension portion 61 may be inclined from the bottom end of the first extension portion 11 toward the lower mounting portion 14.

Referring to FIG. 13, the first end extension portion 61 may include a front surface 61a connecting the front surface 21 of the first extension portion 11 and the front surface 81 of the lower mounting portion 14, and the first end extension portion 61 may include a rear surface 61b connecting the rear surface 22 of the first extension portion 11 and the rear surface 82 of the lower mounting portion 14. The front surface 61a of the first end extension portion 61 may be inclined to correspond to an offset distance between the front surface 21 of the first extension portion 11 and the front surface 81 of the lower mounting portion 14. The rear surface 61b of the first end extension portion 61 may be inclined to correspond to an offset distance between the rear surface 22 of the first extension portion 11 and the rear surface 82 of the lower mounting portion 14.

Referring to FIG. 10, the second end extension portion 71 may extend from the bottom end of the second extension portion 12 toward the lower mounting portion 14 along the longitudinal direction of the reinforcing member 10. To correspond to an offset distance between the second extension portion 12 and the lower mounting portion 14, the second end extension portion 71 may be inclined from the bottom end of the second extension portion 12 toward the lower mounting portion 14.

Referring to FIG. 13, the second end extension portion 71 may include a front surface 71a connecting the front surface 31 of the second extension portion 12 and the front surface 81 of the lower mounting portion 14, and the second end extension portion 71 may include a rear surface 71b connecting the rear surface 32 of the second extension portion 12 and the rear surface 82 of the lower mounting portion 14. The front surface 71a of the second end extension portion 71 may be inclined to correspond to an offset distance between the front surface 31 of the second extension portion 12 and the front surface 81 of the lower mounting portion 14. The rear surface 71b of the second end extension portion 71 may be inclined to correspond to an offset distance between the rear surface 32 of the second extension portion 12 and the rear surface 82 of the lower mounting portion 14.

Referring to FIG. 12, the first connection rib 51 may connect the bottom end of the first extension portion 11 and the bottom end of the second extension portion 12 along the width direction of the reinforcing member 10. The first connection rib 51 may include the front surface 51a connecting the front surface 21 of the first extension portion 11 and the front surface 31 of the second extension portion 12, and the first connection rib 51 may include the rear surface 51b connecting the rear surface 22 of the first extension portion 11 and the rear surface 32 of the second extension portion 12. The front surface 51a of the first connection rib 51 may be inclined to correspond to an offset distance between the front surface 21 of the first extension portion 11 and the front surface 31 of the second extension portion 12. The rear surface 51b of the first connection rib 51 may be inclined to correspond to an offset distance between the rear surface 22 of the first extension portion 11 and the rear surface 32 of the second extension portion 12.

Referring to FIG. 13, the second connection rib 52 may connect the first end extension portion 61 and the second end extension portion 71 along the width direction of the reinforcing member 10. The second connection rib 52 may include the front surface 52a connecting the front surface 61a of the first end extension portion 61 and the front surface 71a of the second end extension portion 71, and the second connection rib 52 may include the rear surface 52b connecting the rear surface 61b of the first end extension portion 61 and the rear surface 71b of the second end extension portion 71. The front surface 52a of the second connection rib 52 may be inclined to correspond to an offset distance between the front surface 61a of the first end extension portion 61 and the front surface 71a of the second end extension portion 71. The rear surface 52b of the second connection rib 52 may be inclined to correspond to an offset distance between the rear surface 61b of the first end extension portion 61 and the rear surface 71b of the second end extension portion 71. An angle of inclination of the front surface 52a of the second connection rib 52 and an angle of inclination of the rear surface 52b of the second connection rib 52 may gradually decrease toward the lower mounting portion 14.

According to an exemplary embodiment of the present disclosure, the reinforcing member 10 may be made of a synthetic resin material. The first extension portion 11, the second extension portion 12, the upper mounting portion 13, the lower mounting portion 14, the middle connection portions 15 and 16, the upper connection portion 17, and the lower connection portion 18 may be formed of a unitary one-piece structure by a molding method.

Referring to FIG. 10 and FIG. 15, the upper mounting portion 13 made of synthetic resin may include metal hardware 85 through which a fastener such as the bolt 87 extends, and the metal hardware 85 may be a cylindrical bushing or nut. The metal hardware 85 may be integrally formed with the upper mounting portion 13 by insert molding, and accordingly the mounting stiffness of the upper mounting portion 13 may be improved by the metal hardware 85.

Referring to FIG. 10 and FIG. 15, the lower mounting portion 14 may include the metal hardware 85 through which a fastener such as the bolt 87 extends, and the metal hardware 85 may be a cylindrical bushing or nut. The metal hardware 85 may be integrally formed with the lower mounting portion 14 by insert molding, and accordingly the mounting stiffness of the lower mounting portion 14 may be improved by the metal hardware 85.

As set forth above, according to exemplary embodiments of the present disclosure, the reinforcing member having the first extension portion and the second extension portion spaced apart from each other may be mounted on the partition so that the reinforcing member may suppress the deformation of the partition and the vehicle body. In particular, torsional stiffness of the partition and torsional stiffness of the vehicle body may be improved.

Hereinabove, although embodiments of the present disclosure have been described with reference to exemplary embodiments and the accompanying drawings, the embodiments of the present disclosure are not limited thereto, but may be variously modified and altered by those skilled in the art to which the present disclosure pertains without departing from the spirit and scope of the present disclosure claimed in the following claims.

What is claimed is:

1. A vehicle reinforcing member comprising:
a first extension portion extending to a predetermined length;
a second extension portion spaced apart from the first extension portion;
a first upper mounting portion disposed at a top end of the first extension portion and a second upper mounting portion disposed at a top end of the second extension portion; and
a first lower mounting portion disposed at a bottom end of the first extension portion and a second lower mounting portion disposed at a bottom end of the second extension portion.

2. The vehicle reinforcing member according to claim 1, wherein the first extension portion is spaced apart from the second extension portion along a longitudinal axis of a vehicle body.

3. The vehicle reinforcing member according to claim 1, wherein the first extension portion is spaced apart from the second extension portion along a width axis of a vehicle body.

4. The vehicle reinforcing member according to claim 1, wherein the first extension portion is spaced apart from the second extension portion along a height axis of a vehicle body.

5. The vehicle reinforcing member according to claim 1, further comprising a middle connection portion connecting the first extension portion and the second extension portion.

6. The vehicle reinforcing member according to claim 1, wherein:
the first upper mounting portion is offset with respect to the top end of the first extension portion; and
the second upper mounting portion is offset with respect to the top end of the second extension portion.

7. The vehicle reinforcing member according to claim 6, further comprising:
a first upper connection portion connecting the top end of the first extension portion to the first upper mounting portion; and
a second upper connection portion connecting the top end of the second extension portion to the second upper mounting portion.

8. The vehicle reinforcing member according to claim 7, wherein:
a cross section of the first upper connection portion gradually changes from the top end of the first extension portion toward the first upper mounting portion; and
a cross section of the second upper connection portion gradually changes from the top end of the second extension portion toward the second upper mounting portion.

9. The vehicle reinforcing member according to claim 1, wherein:
the first lower mounting portion is offset with respect to the bottom end of the first extension portion; and
the second lower mounting portion is offset with respect to the bottom end of the second extension portion.

10. The vehicle reinforcing member according to claim 9, further comprising:
a first lower connection portion connecting the bottom end of the first extension portion to the first lower mounting portion; and
a second lower connection portion connecting the bottom end of the second extension portion to the second lower mounting portion.

11. The vehicle reinforcing member according to claim 10, wherein:
a cross section of the first lower connection portion gradually changes from the bottom end of the first extension portion toward the first lower mounting portion; and
a cross section of the second lower connection portion gradually changes from the bottom end of the second extension portion toward the second lower mounting portion.

12. The vehicle reinforcing member according to claim 1, wherein:
the first upper mounting portion and the second upper mounting portion are mounted on an upper portion of a partition of a vehicle body; and
the first lower mounting portion and the second lower mounting portion are mounted on respective side portions of the partition of the vehicle body.

13. The vehicle reinforcing member according to claim 1, wherein:
each of the first upper mounting portion and the second upper mounting portion comprises first cylindrical hardware through which a first fastener extends; and
each of the first lower mounting portion and the second lower mounting portion comprises second cylindrical hardware through which a second fastener extends.

14. A vehicle comprising:
a vehicle body comprising a partition disposed between compartments of the vehicle, wherein the partition comprises an upper portion extending in a width direction of the vehicle body and a pair of side portions disposed at each end of the upper portion;
a first extension portion extending to a predetermined length;
a second extension portion spaced apart from the first extension portion;
a first upper mounting portion disposed at a top end of the first extension portion and mounted on the upper portion of the partition;
a second upper mounting portion disposed at a top end of the second extension portion and mounted on the upper portion of the partition;
a first upper connection portion connecting the top end of the first extension portion to the first upper mounting portion;
a second upper connection portion connecting the top end of the second extension portion to the second upper mounting portion;
a first lower mounting portion disposed at a bottom end of the first extension portion and mounted on a first side portion of the pair of side portions of the partition; and
a second lower mounting portion disposed at a bottom end of the second extension portion and mounted on a second side portion of the pair of side portions of the partition.

15. The vehicle according to claim 14, wherein the first extension portion is spaced apart from the second extension portion along a longitudinal axis of the vehicle body.

16. The vehicle according to claim 14, wherein the first extension portion is spaced apart from the second extension portion along a width axis of the vehicle body.

17. The vehicle according to claim 14, wherein the first extension portion is spaced apart from the second extension portion along a height axis of the vehicle body.

18. The vehicle according to claim 14, further comprising a middle connection portion connecting the first extension portion and the second extension portion.

19. The vehicle according to claim 14, wherein:
the first upper mounting portion is offset with respect to the top end of the first extension portion;
the second upper mounting portion is offset with respect to the top end of the second extension portion;
a cross section of the first upper connection portion gradually changes from the top end of the first extension portion toward the first upper mounting portion; and
a cross section of the second upper connection portion gradually changes from the top end of the second extension portion toward the second upper mounting portion.

20. The vehicle according to claim 14, further comprising:
a first lower connection portion connecting the bottom end of the first extension portion to the first lower mounting portion, wherein a cross section of the first lower connection portion gradually changes from the bottom end of the first extension portion toward the first lower mounting portion; and
a second lower connection portion connecting the bottom end of the second extension portion to the second lower mounting portion, wherein a cross section of the second lower connection portion gradually changes from the bottom end of the second extension portion toward the second lower mounting portion.
